(19) United States
(12) Patent Application Publication
(10) Pub. No.: US 2009/0206193 A1
(43) Pub. Date: Aug. 20, 2009

(54) Ballistically deployed telescoping aircraft wing

(76) Inventor: David J. File, Huntington Beach, CA (US)

Correspondence Address: HAYNES AND BOONE, LLP;IP Section, 2323 Victory Avenue, SUITE 700, Dallas, TX, 75219, US

(21) Appl. No.: 11/450,720

(22) Filed: Jun. 9, 2006

(51) Int. Cl. B64C 3/54; B64C 1/00

(52) U.S. Cl. 244/13; 244/218

(57) ABSTRACT

An apparatus for increasing an aerodynamic surface area of an aircraft, e.g., a wing thereof, includes coaxially disposed first and second elongated airfoils and an inflatable device arranged to move the first airfoil coaxially relative to the second airfoil. The second airfoil has a root end fixed to the vehicle and an opposite outboard end, and the first airfoil is arranged to move axially between a retracted position generally inboard of the outboard end of the second airfoil and a deployed position generally outboard thereof. When the movable airfoil is deployed, a latching mechanism locks it in position. The inflatable device can include a collapsible duct that is sealed at one end and coupled at a second end to an inflating source, such as a reservoir of a compressed gas or a pyrotechnic gas generator.

### BACKGROUND

This invention pertains, in general, to aircraft flight surfaces, both primary and secondary, including wings, canards, fins and other aerodynamic trim and stability surfaces, and in particular, to a ballistically deployed, telescoping aircraft lift and/or control surface.

In light of the rapidly evolving nature of global conflicts, including the war on terrorism, and the concomitant evolution of the missions required of manned and unmanned aircraft and aerial vehicles (UAVs) utilized in those conflicts, there has been a recent upsurge in interest in the concept of “morphing aircraft.” A morphing aircraft is an aerial vehicle that is capable of carrying out two distinctly different missions, e.g., both long range/endurance reconnaissance missions and high speed/maneuverability attack missions, through the alteration of the shape and/or size of selected aerodynamic surfaces of the vehicle, e.g., the wings or empennage thereof.

For example, folding wings have been used on carrier-based aircraft for many years to enable a greater number of aircraft to be stored below deck. Folding, pop-out, variable-sweep, “scissor” and telescoping wings have all been used to reduce vehicle size, e.g., for stowage of winged missiles and ordinance, such as ship- or air-launched cruise missiles. An example of a compact folding wing said to be capable of withstanding high G-forces is described in U.S. Pat. No. 6,260,798 to Casiez et al. Telescoping wings have also been used to achieve variable vehicle aerodynamic characteristics, as described in, e.g., U.S. Pat. Nos. 4,691,881 to Gioia; 4,181,277 to Gerhardt; and, 3,672, 608 to Gioia et al.

Historically, rotatable, or variable-sweep wings have been used with good success in high speed military aircraft, and were at one time proposed for supersonic commercial transports. Aircraft of note using rotating, or variable sweep wings include the B-1 bomber and the F-111 long-range fighter-bomber aircraft. Folding wings were used on the XB-70 Mach 3 high altitude bomber, enabling improved aircraft aerodynamic and stability performance. These aircraft were able to travel at high subsonic and supersonic speeds due largely to changes in wing geometry.

However, the analysis of deployment and reliability of folding wing assemblies is inherently difficult and complex. The geometry changes and combinations of vehicle and folding panel orientations require a substantial amount of simulation and testing. Further, folding panels require deployment clearances that a telescoping wing does not need, because a telescoping wing panel has only a single degree of freedom relative to the parent vehicle or assembly. Additionally, folding wings essentially double the volume required for their stowage, compared to that required by a telescoping wing section stowage arrangement.

Variable swept wings do not allow for a reduction in wetted area with changes in sweep. Vehicles using this morphing feature thus place a greater priority on speed changes. Overall performance is penalized at high speeds due to unneeded wing area, and at low speeds, by increased weight of installed wing-body pivot structures.

In light of the foregoing, telescoping wings are currently being examined for such high/low speed “multi-missions,” and there is thus a long felt but as yet unsatisfied need in the field of aviation for a compact telescoping aircraft wing or other flight surface assembly that is stowable in as small of a volume as possible, and yet which can be deployed dependably and rapidly.

### BRIEF SUMMARY

In accordance with the exemplary embodiments thereof described herein, there is provided a ballistically deployed, telescoping wing or other aerodynamic surface of an aircraft or other aerial vehicle, such as a canard or an attitude control surface, that is stowable in an optimally small volume, and that can be deployed dependably during flight and within only a fraction of a second.

In one exemplary embodiment thereof, the telescoping aerodynamic surface comprises coaxially disposed first and second elongated rigid airfoils or wing sections, and an inflatable device coupled between the airfoils and adapted to explosively move, or extend, the first airfoil coaxially relative to the second airfoil in only a fraction of a second. The second airfoil has a root end fixed to a fuselage of the aerial vehicle and an opposite outboard end, and the first airfoil is arranged to move axially between a retracted position generally inboard of the outboard end of the second airfoil, and a deployed position generally outboard thereof.

In one possible embodiment, the second airfoil generally surrounds the first airfoil when the latter is in the retracted position. In another, preferred exemplary embodiment, the first airfoil generally surrounds the second airfoil when the former is in the retracted position, to provide for wing structure or the storage of fuel or other vehicle provisions within the second airfoil. In either embodiment, a mechanism can be provided for latching the first, or moveable, airfoil at a selected axial position, e.g., in the fully deployed position, relative to the second, or fixed airfoil. In either embodiment, the latching mechanism can also function to carry aerodynamic loads acting on the first airfoil into the second airfoil, and thence, into the structure of the vehicle's fuselage.

Additionally, the exemplary apparatus can further comprise 1) a mechanism for equalizing the pressure between the inside and the outside of the first airfoil during the relative axial movement thereof, and 2) a mechanism for guiding the first airfoil coaxially during the extension thereof, such that the first airfoil remains substantially axially aligned with the second, inboard airfoil during the extension process. In one exemplary embodiment, the pressure equalizing mechanism can comprise an arrangement of simple vent holes of an appropriate size and location in the first airfoil, or alternatively, a mechanism that controllably introduces a pressurized gas into the first airfoil during its deployment.

In one advantageous, embodiment, the inflatable device comprises a flexible tube piston, i.e., a woven fiber tube, of a type similar to that used in some aircraft seat ejection mechanisms, that is sealed at a first end and coupled at a second end to an inflating source, such as a reservoir of compressed gas, e.g., N₂, or alternatively, to a pyrotechnic gas generator. In an alternative embodiment, the inflatable device can comprise a hollow cylinder having a closed end and an opposite open end, a connecting rod and a piston conjointly movable within the cylinder, and a valve or other apparatus for selectably coupling an inflating source to the interior of the cylinder between the piston and the closed end of the cylinder. In either embodiment, the inflation gas control mechanism preferably includes an electromagnetically, hydraulically or pyrotechnically actuated regulator valve or gas generating mechanism, for the rapid and controlled introduction of a pressurized gas into the inflatable device.

In another exemplary embodiment, an aerial vehicle, such as a UAV or a cruise missile, comprises an aerodynamic center body, an aerodynamic surface moveable with respect to the center body, and a mechanism for ballistically deploying the aerodynamic surface from a retracted position relative to the center body to a deployed position relative thereto. The aerodynamic surface can include one or more a moveable aerodynamic control surfaces, such as a slat, a flap, an aileron or the like. The aerodynamic surface can comprise two or more telescoping aerodynamic surfaces, and may be completely recessed within the center body of the aerial vehicle when it is disposed in the retracted position.

The apparatus of the invention enables rapid deployment of additional lift and control area and span, thereby enabling sustained flight and benefiting performance of vehicle secondary mission segments. The ballistically deployed apparatus combines the benefits of quick deployment with increased levels of load capacity, stiffness and reduced weight.

A better understanding of the above and many other features and advantages of the aerial morphing apparatus of the present invention may be obtained from a consideration of the detailed description of the exemplary embodiments thereof below, particularly if such consideration is made in conjunction with the appended drawings, wherein like reference numerals are used to identify like elements illustrated in one or more of the figures thereof.

### BRIEF DESCRIPTION OF THE DRAWINGS

FIG. 1 is graph of two flight performance curves of two substantially similar, elongated airfoil or wing sections moving through air, wherein a shorter one of the two wings is shown by a dashed line and a longer one of the wings by a solid line, and in which the respective coefficients of lift C_{L} of the two wings are plotted as a function of the respective coefficients of drag C_{D} thereof at varying speeds;

FIG. 2 is a partial top plan cross-sectional view of an exemplary embodiment of a ballistically deployed telescoping wing in accordance with the present invention;

FIG. 3 is a schematic functional diagram of an exemplary embodiment of a collapsible gas tube piston and pressurized gas apparatus for ballistically deploying the exemplary telescoping wing of FIG. 2;

FIG. 4 is a set of three graphs respectively showing profiles of the energy used by, the velocity of, and the pressure behind, a gas tube piston of the wing during deployment thereof, as a function of time;

FIGS. 5A and 5B are a pressure-area diagram of the outboard tip of the deployed wing, and a plot of the displacement of the moveable section of the wing with time during deployment, respectively;

FIGS. 6A-6C are sequential partial top plan cross-sectional views of the exemplary wing of FIG. 2 being deployed;

FIGS. 7A and 7B are schematic partial cross-sectional views of two alternative embodiments of a telescoping wing, respectively showing the wings both before and after deployment thereof;

FIG. 8 is a partial cross-sectional view of an exemplary embodiment of a latching mechanism of the exemplary telescoping wing, as seen along the section lines 8-8 taken in FIG. 2;

FIG. 9 is a partial cross-sectional view of the latching mechanism of FIG. 8, as seen along the section lines 9-9 taken in FIG. 8;

FIG. 10 is a partial cross-sectional view of an exemplary alternative embodiment of a latching mechanism of the telescoping wing, as seen along the section lines 10-10 taken in FIG. 2;

FIG. 11 is a partial cross-sectional view of the alternative latching mechanism of FIG. 10, as seen along the section lines 11-11 taken in FIG. 10;

FIGS. 12A-12D are sequential partial cross-sectional views of the exemplary latching mechanism of FIGS. 8 and 9, showing the operation thereof during deployment of the wing;

FIGS. 13A and 13B are upper front perspective views of yet another exemplary latching mechanism of the telescoping wing;

FIG. 14 is a partial top plan cross-sectional view of another exemplary embodiment of a ballistically deployed telescoping wing having a plurality of telescoping sections; and,

FIGS. 15A and 15B are schematic partial cross-sectional views of an alternative embodiment of a telescoping wing that is fully recessed within an aircraft fuselage when retracted, showing the wing both before and after deployment thereof.

### DETAILED DESCRIPTION

Modern aerial vehicles, which can include missiles or manned or unmanned aircraft and aerial vehicles, can have a wide variety of flight profiles, depending on their assigned mission. The takeoff and landing phases of an aerial vehicle's mission profile directly affect system operability and indirectly affect overall system efficiency in that they can penalize other mission segments by imposing wing area constraints and non-synergistic weight penalties to the other segments. Wing loading is directly related to flight velocity and maximum-achievable lift coefficients. Thus, the ability of an aerial vehicle to selectively adjust its wing area during a mission can result in several benefits. These benefits include, for example, enhanced operational capability, such as 25% shorter takeoff runs and slower approach speeds. Slower approach speeds can be vital to landing safety for both pilot, vehicle and ground support assets. Additionally, by increasing the takeoff lift coefficient (C_{L}), the overall vehicle planform area can be reduced, which directly reduces net drag.

Other vehicle mission parameters, including range and flight duration, can also benefit from variable wing areas. For example, by increasing the takeoff lift coefficient, the overall vehicle planform area can be reduced, which directly reduces net drag. An increase in takeoff lift can be achieved by adding a “pop out” telescoping wing or canard, which for a brief period of time during takeoff, can result in a significant savings in fuel over the total flight. A telescoping wing can thus nearly double, or conversely, nearly halve, the effective wing area, thereby modifying both wing area and wing span to effect the desired flight efficiencies.

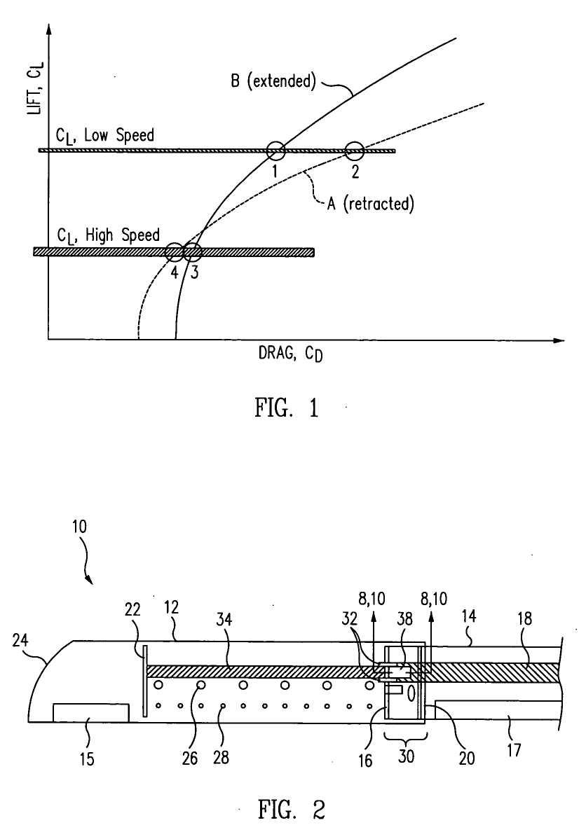

FIG. 1 is a graph of two aerodynamic performance curves of two substantially similar wing sections moving through air, wherein a shorter or retracted one A of the two wing sections is represented by a dashed line, and a longer or extended one B by a solid line, and in which the respective coefficients of lift C_{L} of the two wings are respectively plotted as a function of their respective coefficients of drag C_{D} at continuously decreasing speeds. Two operating points are shown for each wing section, viz., one at a relatively low speed and one at a relatively high speed, respectively represented by the encircled points 2 and 4 for the short or retracted wing A, and by the encircled points 1 and 3 for the long or extended wing section B. As may be seen in FIG. 1, at lower speeds, the lift factor C_{L} must be relatively high, and as a matter of general flight principles, the ratio of lift-to-drag (L/D), which is proportional to C_{L}/C_{D}, will also at its greatest value. A telescoping wing thus enables the performance of a wing to “jump” from point 3 to point 4 of FIG. 1 by retracting a section of the wing during high speed operations, thus shortening the length and decreasing the area of the wing, and thereby gaining an increase in the lift-to-drag ratio L/D at that higher speed. Conversely, during low speed operations, the wing segment can be extended to increase the wing span and area, thereby enabling the vehicle's performance to “jump” from point 2 to point 1 of FIG. 1, and again maximize the L/D ratio at the lower speed.

An exemplary preferred embodiment of a ballistically deployed telescoping wing 10 for an aircraft or other aerial vehicle capable of effecting the above “morphing” effect is illustrated in the partial cross-sectional top plan view of FIG. 2, in which the upper surface, or skin, of the wing has been removed for illustration purposes. The wing of FIG. 2, which is shown in the fully deployed, or extended position, comprises a first elongated rigid airfoil, or outboard wing section 12, coaxially supported on a second elongated rigid airfoil, or inboard wing section 14, and arranged to move coaxially outward with respect to the first airfoil during deployment. As used herein, “ballistically deployed” means the use of a pressurized gas, such as that provided by bottle of compressed gas, or produced by a pyrotechnic device at ignition, such as a Kaufmann engine starter or ejection seat cartridge, as a motive force to extend the movable airfoil section very rapidly relative to the fixed airfoil section.

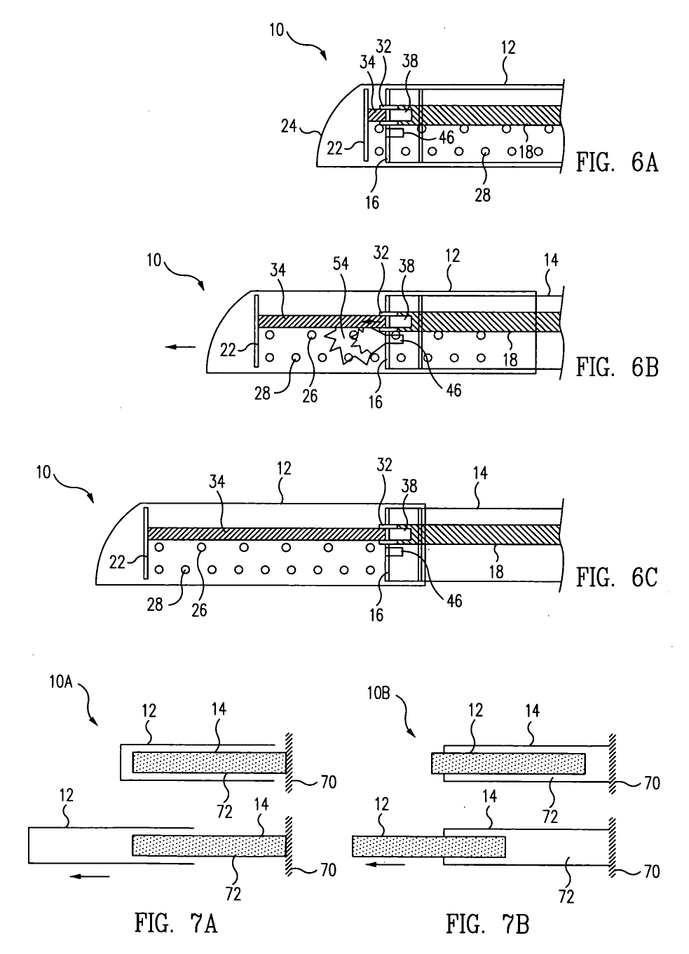

The inboard airfoil 14 has a root end fixed to a fuselage or centerbody of the aircraft (not illustrated) and an opposite outboard end 16, and the first, outboard airfoil 12 is arranged to move axially between a retracted position generally inboard of the outboard end of the second airfoil (see FIG. 6A), and a deployed position generally outboard thereof, as shown in FIGS. 2 and 6C. The inboard airfoil further includes a conventional axial wing spar 18 that supports the wing 10 on the aircraft fuselage in a conventional, cantilevered fashion.

The outboard airfoil 12 likewise includes an inboard end 20 and an outboard, or tip end 22, which may comprise a streamlined fairing 24, such as that shown in the figure, or alternatively, a “winglet” or a Hoerner tip. The outboard airfoil may also include a plurality of pressure-equalizing vents 26, the purpose of which is described below, as well as a plurality of glides, or spacers 28, which function to keep the two wing sections concentrically spaced relative to each other during deployment of the moving section 12 relative to the fixed section 14. Both the outboard and inboard airfoils may incorporate one or more conventional moveable flight control surfaces, such as the ailerons 15 and 17 illustrated in FIG. 2.

In the fully retracted position (see FIG. 6A), the two airfoils 12 and 14 substantially overlap each other laterally, with their respective inboard and outboard ends disposed adjacent to each other, such that the overall span, and hence, projected area, of the wing 10 is substantially reduced, relative to those of the fully extended position shown in FIGS. 2 and 6C, in which the two airfoils overlap each other in only a relatively small region 30. As illustrated in FIG. 2, this overlap region 30 includes two features associated with the deployment of the wing, viz., one or more latching mechanisms 32, described in more detail below, used to lock the outboard airfoil in the extended position relative to the inboard airfoil, and a gas-operated expulsive device, or gas tube piston 34, including a pressurized gas control apparatus 36, utilized to deploy the wing ballistically in the following manner.

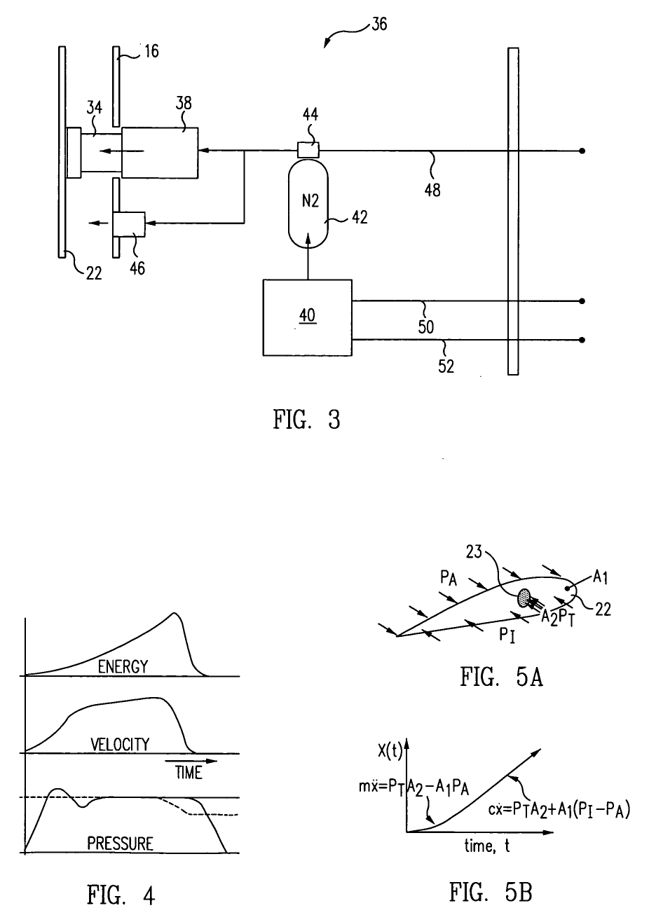

In a preferred exemplary embodiment, the gas tube piston 34 comprises a collapsible, flexible, inflatable fabric duct, or tube, having a first end coupled to the outboard end 22 of the moveable outboard wing section 12, preferably at the centroid 23 thereof, as shown in FIG. 5A, and a second end coupled to a hollow cylinder portion 38 of the gas control apparatus 36, as illustrated schematically in FIG. 3. The cylinder portion 38 preferably includes a frangible load-bearing material that is adapted to maintain the assembly position and integrity of the wing 10 in the retracted, or non-deployed condition during routine handling and pre-deployment aerodynamic loading.

As shown in FIG. 3, in addition to the foregoing components, the inflation gas control apparatus 36 further comprises a fire control unit 40, a source 42 of a pressurized gas, e.g., nitrogen (N₂), or alternatively, a pyrotechnic gas generator (not illustrated), a main control valve 44, which can comprise an electromagnetically or pyrotechnically actuated valve, and optionally, a second, low-pressure regulator valve 46 for controllably releasing gas into the interior of the outboard airfoil section 12 during the rapid deployment thereof, for equalizing the pressure between the inside and the outside of the first airfoil during its deployment. Actuation of the apparatus can be effected remotely, e.g., from within the aircraft center body, via signal control circuits, either electrical or fluidic, e.g., a power supply circuit 48, an arming circuit 50 and a fire control circuit 52.

As those of skill in the art will appreciate, the collapsible gas piston 34 and associated cylinder 38 and gas control apparatus 36 of the exemplary embodiment of FIG. 3 are similar to the lightweight, high-strength expandable “aerostabilizer” technology developed by Vertigo, Inc., of Lake Elsinore, Calif., the “engineered inflatables” developed by ILC Dover, LP, of Frederica, Del., and those of other known woven product aerospace suppliers.

A gas-actuated cylinder 38, solid piston 34 and elongated connecting rod arrangement could also accomplish the same outer panel 12 deployment function, but as will be appreciated, at least the cylinder 38 and rod portions will necessarily be as long as the required stroke of the piston 34, thereby potentially resulting in a significant weight and volume penalty. Thus, at smaller scales, a heavier, gas-actuated cylinder 38 and piston-rod arrangement 34 may be practical where the pressurized cylinder carries flight loads as part of the integrated flight surface structure. However, the fabric piston 34 constitutes a preferred embodiment because, in addition to reliably deploying the moveable portion of the wing section, it can also function to absorb the stopping loads of the outboard wing section 12 at the end of the deployment cycle efficiently and reliably, thereby eliminating secondary stopping/damping mechanisms, such as lanyards, dashpots and dampers, and reducing the overall parts count.

Alternates to the pressurized gas system 36 illustrated can include solid or liquid propellant (hypergolic or pyrotechnic) combinations to provide the pressurized gas. However, due to burn-rate sensitivities to back pressure, fully-pyrotechnic deployments will have a greater dispersion in actual deployment conditions, e.g., at high vs. low altitudes.

During its rapid inflation with a pressurized gas, the fabric tube portion of the piston 34 provides controlled forces both during, and at the end of, wing deployment, and thus represents a compact, low-mass device that minimizes overall dynamic/inertial energy and forces, and also provides additional benefits of dampening and braking forces at the end of its deployment by absorbing the deceleration forces involved in stopping the moving wing section 12 in the tube's woven elastic fibers. FIG. 4 is a set of three graphs respectively illustrating profiles of the kinetic energy and velocity of, and the pressure within, the gas tube piston 34 during an explosive wing deployment as a function of time. As shown by the dashed line in the lower graph of FIG. 4, the pressure within the piston tube can be allowed to bleed off after the wing is fully deployed, or alternatively, can be maintained relatively constant by a suitable regulation of the gas control apparatus 36.

FIGS. 5A and 5B are respectively a pressure-area diagram of the pressures acting on various areas of the outboard wing tip 22 of the deployed wing section 12 during deployment, and a plot of its lateral displacement x(t) with time during deployment, respectively. The generalized equation of state for the deployment process is given by the relationship,

m(t)\ddot{x}+c(t)\dot{x}+k(t)x=P_{T}A₂+(P_{I}−P_{A})A₁,

where m is the mass of the moving airfoil 12, A₁ is the area of its outboard tip, A₂ is the area of the gas tube piston 34 acting at the centroid 23 of the tip, P_{A} is the external pressure acting on the tip, P₁ is the internal pressure acting on the tip, and P_{T} is the pressure in the gas piston.

While a “one-shot” wing deployment scenario may be appropriate for, e.g., a non-recoverable weapon application, this does not preclude other options for retrieval and repackaging of the deployed wing panel hardware, similar to the repacking of parachutes, and a two-shot and/or even multiple cycling assemblies could be accomplished using, e.g., two air pistons and servo-actuated latching features.

FIGS. 6A-6C are sequential partial top plan cross-sectional views of the exemplary wing 10 being ballistically deployed. Prior to deployment, the outboard airfoil 12 of the telescoping wing is locked in place by the frangible links associated with the cylinder portion 38 of the gas-tube piston 34 assembly described above. At the start of deployment (FIG. 6A), actuation of the high pressure regulator valve 44 enables pressurized gas to flow from the high pressure source 42 into to the cylinder portion 38 of the tube piston 34, causing the tube to expand in the lateral direction, as indicated by the arrow in FIG. 6B. An optional second low pressure regulator/valve mechanism 46 can simultaneously release gas 54 into the interior of the outboard airfoil 12, to prevent the formation of a vacuum inside the outboard airfoil during its deployment. This low-pressure, volume-filling, or pressure-equalizing function can also be effected by the provision of suitable vent holes 26 in the outboard airfoil, or alternatively, by a “slow bum” pyrotechnical device. The size of the vent holes and/or quantity of a secondary regulated, low-pressure flow into the outboard panel interior volume is regulated so as to substantially match the pressures inside and outside of the deploying wing section and thereby prevent a potential collapse of the panel due to a large pressure differential.

At the end of the deployment of the outboard airfoil 12, the woven fabric of the tube piston 34 functions to absorb the kinetic energy and momentum of the airfoil (FIG. 4, top graph) as fiber strain energy, and also serves to brake and dampen the stopping loads imposed by the moving section on the fixed, inboard airfoil 14, while simultaneously creating an initial pretension in the overall latched assembly, as shown in FIG. 6C. At the end of deployment, the deployed airfoil 12 is preferably latched, or fixed, in the deployed position relative to the fixed airfoil 14 by use of the latching mechanisms 32 described below.

FIGS. 7A and 7B are schematic partial cross-sectional views, looking forward, of two possible alternative embodiments of a telescoping wing 10A and 10B, respectively, each illustrating a respective one of the wings both before and after deployment. In both examples, the second, or inboard airfoil 14 has an inboard end fixed to, e.g., an aircraft fuselage 70, and the first airfoil 12 moves coaxially relative to the second airfoil. In FIG. 7A, the first, or moving airfoil 12 surrounds, or encompasses, the second airfoil 14 when the former is disposed in the retracted position (upper view), whereas, in FIG. 7B, the second airfoil surrounds the first airfoil when the latter is in the retracted position (upper view). While the present invention contemplates that either embodiment can be used advantageously, depending on the particular circumstances at hand, it will be noted that, in the embodiment of FIG. 7A, the fixed, inboard airfoil 14 includes a fixed, interior volume 72 that can be used advantageously for either wing structure or storage of provisions, e.g., fuel, irrespective of the position of the moving, outboard airfoil 14, whereas, in the embodiment of FIG. 7B, as the moving, outboard airfoil 12 moves internally into and out of the inboard airfoil with retraction and extension, the interior volume 72 of the inboard airfoil is essentially wasted, and the structural and storage capabilities of the inboard panel are therefore compromised. Accordingly, the embodiment of FIG. 7A is preferred where the interior of the fixed airfoil is used for necessary structure and/or storage of provisions.

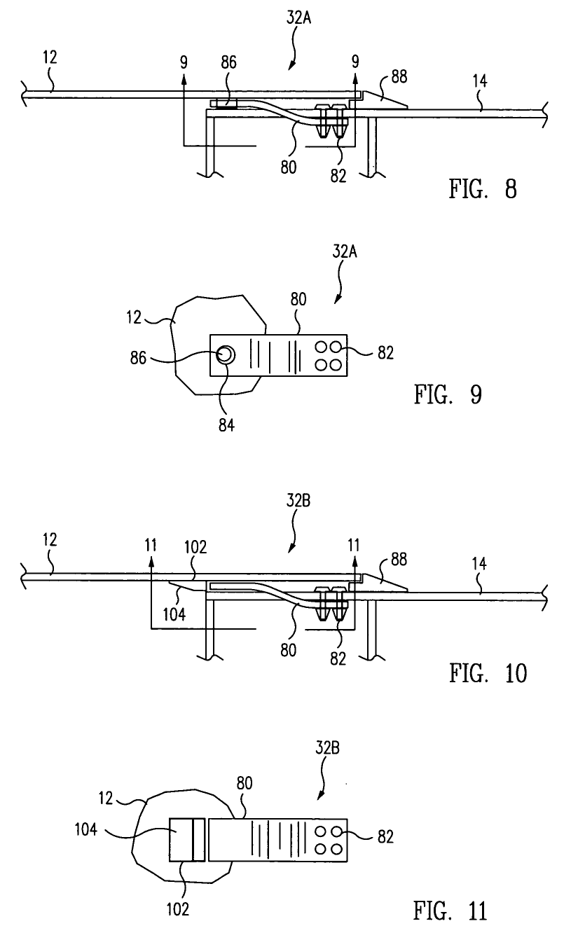

A first exemplary embodiment of a latching mechanism 32A for latching, or fixing, the first, outboard, moving air foil or wing section 12 in the deployed position relative to the second, inboard, fixed air foil or wing section 14, is illustrated in the partial cross-sectional views of FIGS. 8 and 9. As shown in the figures, the first latching mechanism comprises an S-shaped resilient member 80 that is fixed to the structure of the second airfoil 14 by, e.g., a plurality of fasteners 82, and has a locking aperture 84 formed therein. A cylindrical, puck-like engaging member 86 is affixed to the inner surface of the first airfoil 12.

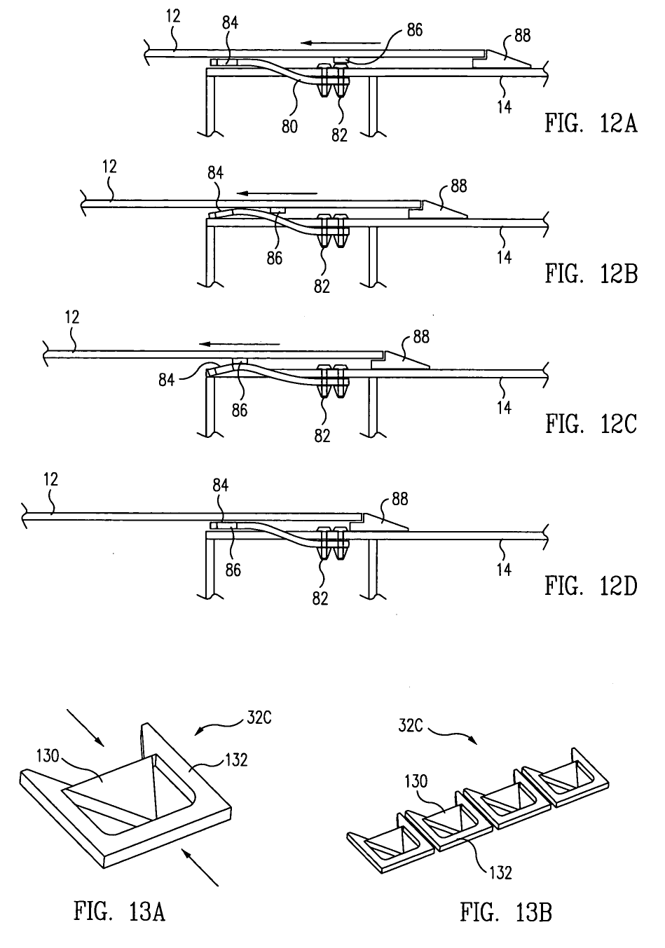

Operation of the first latching mechanism 32A is illustrated in the sequence of FIGS. 12A-12D. As may be seen in FIG. 12A, in the fully retracted position of the wing, the engaging member 86 resides inboard of the resilient member 80. As the outboard airfoil 12 of the wing begins to deploy, the engaging member moves laterally with the first airfoil until it engages the resilient member, thereby deflecting the latter downward, as illustrated in FIG. 12B. As the first airfoil continues to move laterally, the engaging member eventually slides over and enters into the locking aperture 84 of the resilient member, thereby allowing the resilient member to spring back over the engaging member such that the engaging member, and hence, the first airfoil 12, is latched, or fixed, against further lateral movement, as illustrated in FIGS. 8, 9 and 12D.

A second exemplary embodiment of a latching mechanism 32B is illustrated in FIGS. 10 and 11. The second embodiment includes elements that are similar to those of the first embodiment 32A described above, except that the locking aperture 84 of the resilient member and the corresponding engaging member 86 are omitted, and in their place is provided a rectangular engaging member 102 having a ramp, or inclined lower face 104, that engages and deflects the resilient member 80 during deployment. Operation of the second embodiment is also similar to that of the first, except that, in the fully deployed position, as illustrated in FIG. 10, the inboard end of the engaging member abuts the outboard end of the resilient member to prevent inboard movement of the first wing section 12 relative to the second wing section 14.

In either of the latching embodiments above, the latching function can be augmented with a streamlined, resilient, circumferential gap seal 88 that is fixed to the inboard end of the outboard airfoil 12 and slidably disposed around the inboard airfoil 14, such as that illustrated in FIGS. 8, 10 and 12. In the exemplary embodiments illustrated and described above, it is contemplated that a plurality of the latching mechanisms 32A or 32B, e.g., four, be employed within each wing assembly. The number and placement of the latching mechanisms are governed by two competing and traditionally-orthogonal loadings, viz., lift and drag. The four latches are able to transmit bending loads by reacting through these two moment/couples. Shear loads are transmitted between the two wing sections using the overlap area 30 (see FIG. 2) and by the matching rib sections between the inboard and outboard wing sections at its borders. Latch loads are transferred to the wing spar 18 and other structure using suitable brackets and fittings.

The latching subassemblies may also include energy absorption features, components to increase reliability, as well as features for resetting or removing the outboard wing section for refurbishment or inspection of internal hardware.

A third exemplary embodiment of a latching mechanism 32C for the telescoping wing 10 is illustrated in the perspective views of FIGS. 13A and 13B. As may be seen in the enlarged view of FIG. 13A of a single element thereof, each identical element of the third embodiment of latching mechanism comprises a complementary pair of male and female engaging members 130 and 132. The male member 130 comprises a generally triangular shaped, flat body. Each female member 132 comprises a U-shaped body with opposite arms, each having a lock formation. The arms are deflected by the male member when engaged until it passes the lock formations. The arms return to an un-deflected position and the male member snap-locks into a locked position. The locking mechanisms can have various other shapes and configurations without departing from the scope of this invention. In use, respective pluralities of the male and female members are disposed adjacent to each other in a pair of axially aligned, circumferential bands on respective inner and outer surfaces of the fixed and moving wing sections 12 and 14. As the outboard wing section is deployed to its fully extended position, each of the male members 130 engages a corresponding one of the female members in a resilient, over-center latching engagement, as shown in FIG. 13B, to prevent further lateral movement of the outboard section relative to the inboard section.

By now, those of skill in this art will appreciate that many modifications, substitutions and variations can be made in and to the materials, apparatus, configurations and methods of the ballistically deployed telescoping wing of the present invention without departing from its spirit and scope. For example, although the invention has generally been described in the context of a telescoping wing, it should be understood that the teachings of the invention can be applied to almost any aircraft flight surfaces, either primary and secondary, including canards, fins or other aerodynamic lift, trim, or stability surfaces.

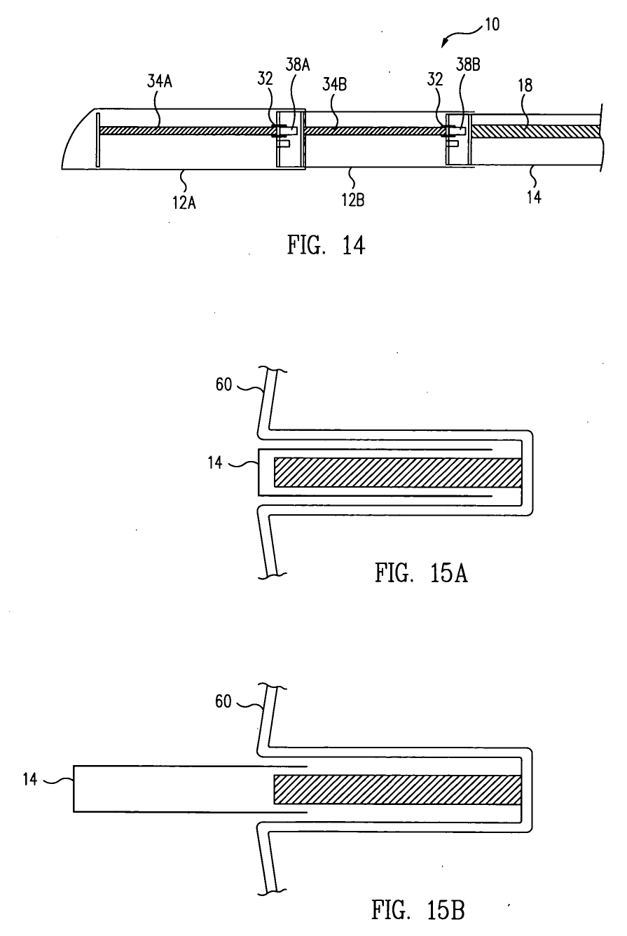

Further, although the telescoping apparatus has been described and illustrated herein as consisting of only two sections, other embodiments are possible, such as wings or fins having three, or even more, telescoping sections, such as that illustrated in FIG. 14, wherein the wing assembly 10 includes two outboard sections 12A and 12B that are axially extendable relative to a third, fixed section 14, and wherein a pair of gas tube piston mechanisms 34A, 38A and 34B, 38B are used to deploy respective ones of the movable sections.

In another possible modification, one or more moveable, telescoping aerodynamic surfaces 14 can be disposed such that they are completely recessed within a fuselage 60 of an aircraft when in a retracted state, as shown schematically in the cross-sectional view looking forward of FIG. 15A and are thus not aerodynamically functional until they are fully deployed, as shown schematically in FIG. 15B.

In light of the foregoing possible variations, the scope of the present invention should not be limited to that of the particular embodiments illustrated and described herein, as they are only exemplary in nature, but rather, should be fully commensurate with that of the claims appended hereafter and their functional equivalents.

What is claimed is:

1. An apparatus for increasing an aerodynamic surface area of an aerial vehicle, comprising:
coaxially disposed first and second elongated airfoils; and,
an inflatable device coupled between the airfoils and adapted to selectably move the first airfoil coaxially relative to the second airfoil.

2. The apparatus of claim 1, wherein the second airfoil has a root end fixed to a fuselage of the airborne vehicle and an opposite outboard end, and wherein the first airfoil is arranged to move axially between a retracted position generally inboard of the outboard end of the second airfoil, and a deployed position generally outboard thereof.

3. The apparatus of claim 2, wherein the first airfoil generally surrounds the second airfoil when the first airfoil is in the retracted position.

4. The apparatus of claim 2, wherein the second airfoil generally surrounds the first airfoil when the first airfoil is in the retracted position.

5. The apparatus of claim 1, further comprising a latching mechanism for securing the first airfoil at a selected axial position relative to the second airfoil.

6. The apparatus of claim 1, further comprising a valve for controlling the flow of a gas into the inflatable device.

7. The apparatus of claim 1, wherein the inflatable device comprises a flexible tube sealed at a first end and coupled at a second end to an inflating source.

8. The apparatus of claim 1, wherein the inflatable device comprises:
a hollow cylinder having a closed end and an opposite open end;
a connecting rod and a piston conjointly movable within the cylinder; and,
a mechanism for selectably coupling an inflating source to the interior of the cylinder between the piston and the closed end of the cylinder.

9. The apparatus of claim 7, wherein the inflating source comprises a reservoir of a compressed gas or a pyrotechnic gas generator.

10. The apparatus of claim 8, wherein the inflating source comprises a reservoir of a compressed gas or a pyrotechnic gas generator.

11. The apparatus of claim 1, further comprising a venting source for equalizing the pressure between the inside and the outside of the first airfoil during the relative coaxial movement thereof.

12. The apparatus of claim 1, wherein the first and second airfoils each comprises a wing, a canard, or an attitude control surface of the aerial vehicle.

13. An aircraft, comprising:
an elongated fuselage;
a pair of wings respectively extending from opposite sides of the fuselage, each wing comprising a pair of telescoping wing sections including an inboard section fixed to the fuselage and an outboard section extendable relative to the inboard section;
a ballistic extending mechanism arranged to extend the outboard section of each wing relative to the inboard section during flight, and,
a locking mechanism for locking the outboard section of each wing at an extended position relative to the inboard section thereof.

14. The aircraft of claim 13, wherein the ballistic extending mechanism comprises a collapsible tube having opposite, closed ends and a valve for selectably coupling a source of a pressurized gas into the interior thereof.

15. The aircraft of claim 14, wherein the collapsible tube comprises a woven fiber wall.

16. The aircraft of claim 14, wherein the source of a pressurized gas comprises a container of a compressed gas or a pyrotechnic gas generator.

17. The aircraft of claim 13, wherein the outboard section of each wing telescopes over the inboard section thereof.

18. The aircraft of claim 17, wherein at least one of the inboard wing sections includes internal fuel tanks.

19. The aircraft of claim 13, further comprising a venting mechanism for introducing a gas into the outboard section of each wing during the extension thereof, such that the pressure inside of the wing section remains substantially the same as the pressure outside of the wing section during the extension thereof.

20. The aircraft of claim 13, further comprising a mechanism for guiding the outboard section of each wing during the extension thereof, such that the outboard section remains substantially aligned coaxially with the inboard section thereof during the extension.

21. An aerial vehicle, comprising:
an aerodynamic center body;
an aerodynamic surface moveable with respect to the center body; and,
a mechanism for ballistically deploying the aerodynamic surface from a retracted position relative to the center body to a deployed position relative thereto.

22. The aerial vehicle of claim 21, wherein the ballistically deploying mechanism comprises:
a collapsible, sealed tube;
a source of a pressurized gas; and,
a mechanism for selectably coupling the pressurized gas into the flexible tube.

23. The aerial vehicle of claim 21, wherein the aerodynamic surface includes a moveable aerodynamic control surface.

24. The aerial vehicle of claim 21, wherein the aerodynamic surface comprises two or more telescoping aerodynamic surfaces.

25. The aerial vehicle of claim 21, wherein the aerodynamic surface is completely recessed within the center body of the aerial vehicle when the aerodynamic surface is in the retracted position.
